(19) United States
(12) Patent Application Publication
(10) Pub. No.: US 2008/0280483 A1
(43) Pub. Date: Nov. 13, 2008

(54) TOOL-LESS INSULATION DISPLACEMENT CONNECTOR (TIDC) LOCKING MARKER CAP

(75) Inventor: Brian L. Curtis, Omaha, NE (US)

Correspondence Address: Muncy, Geissler, Olds & Lowe, PLLC, P.O. BOX 1364, FAIRFAX, VA, 22038-1364, US

(73) Assignee: CommScope, Inc. of North Carolina

(21) Appl. No.: 11/747,852

(22) Filed: May 11, 2007

(51) Int. Cl. H01R 3/00

(52) U.S. Cl. 439/491; 29/749; 439/459

(57) ABSTRACT

A locking marker cap has structural features to snap lock to various types of a tool-less insulation displacement connector (TIDC). When the cap is attached to the TIDC, additional structural features of the cap lock a latch of the TIDC in a closed position to protect the TIDC from being accidentally opened and coincidentally disconnecting the circuit served by the TIDC. In one embodiment, the cap must be removed before the TIDC can be unlatched and opened. At least a top surface of the cap can include indicia such as a color, letter(s) or symbol(s) to indicate a type of circuit served by the protected TIDC.

### BACKGROUND OF THE INVENTION

1. Field of the Invention

The present invention relates to a tool-less insulation displacement connector (TIDC). More particularly, the present invention relates to a cap for coupling with a TIDC to block disengagement of a latch of the TIDC and to optionally indicate a type of connection served by the TIDC.

2. Description of the Related Art

A TIDC is typically used to connect an incoming twisted pair (e.g., service provider line) to an outgoing twisted pair (e.g., a customer line). For example, in a telephone network, a network cable from the central office is connected to a building entrance protector (BEP) located at the customer site, where the individual telephone lines are broken out line by line. The network cable, which consists of a plurality of tip-ring wire pairs that each represent a telephone line, is typically connected to a plurality of connectors within the BEP. The connectors are commonly of the mini-rocker type of TIDCs.

The present assignee's U.S. Pat. No. 6,457,990, which is herein incorporated by reference, describes the typical prior art TIDC. As illustrated in FIGS. 1-3, the prior art TIDC, also referred to as a connector hereinafter, is generally indicated as 10, has a top section, generally indicated as 12, movable between an open position (not shown) and a closed position, and a bottom fixed section, generally indicated as 14. The top section 12 generally comprises a wire retention portion 18 which comprises a substantially rectangular front face 21 having two entrance apertures 22 therein, which lead to two wire insertion holes 20. The top edge of wire retention portion 18 is defined by channel 37. Wire insertion holes 20 are constructed so as to accept wire 30 in a manner known in the art. Top section 12 also has terminal strip receiving portions 26, which are constructed to accept terminal strips 28 when the top section 12 is in its closed position.

As seen in FIG. 1, when top section 12 is in its closed position, terminal strips 28 intersect wire insertion holes 20, and when top section 12 is in its open position (not shown), terminal strips 28 do not intersect wire insertion holes 20. In order to establish an electrical and mechanical connection between the wire 30 and the terminal strip 28, a user first opens the top section 12, i.e., pivots top section 12 about hinged axis 32 to its open position, inserts a wire 30, and then closes the top section 12. Upon closing top section 12 of connector 10, wire 30 is brought into electrical and mechanical contact with terminal strip 28. To remove the wire and/or break the electrical connection, the process is reversed.

As seen in FIG. 1, the top movable section 12 comprises a latch, generally indicated as 15, movable between an engaged position and a disengaged position. Latch 15 generally comprises a crossbar member 40 connected to two downwardly projecting side members 42. As seen in FIG. 1, when top section 12 is in its closed position and the latch 15 is in its engaged position, latch engaging portion 16 engages latch retaining portion 38 on the bottom section 14 of the connector 10. Thus, when the top section 12 is in its closed position and the latch 15 is in its engaged position, the latch 15 maintains top section 12 in its closed position. In order to open top section 12, latch 15 must first be moved to its disengaged position.

To move latch 15 between its engaged position and its disengaged position, a user generally grips the connector 10 between a rear finger grip portion 34 and latch grip portion 35 which forms part of the front face of latch 15. Upon squeezing or other pressure, crossbar member 40 of latch 15 pivots about living hinge 24 away from channel 37 and towards recess 36. Latch 15 is pivoted about living hinge 24 into recess 36 a sufficient distance so as to disengage latch engaging portion 16 from latch retaining portion 38. Once latch engaging portion 16 is disengaged from latch retaining portion 38, top section 12 is able to move to its open position.

FIG. 3 is a top view of the connector 10 of FIGS. 1 and 2. As illustrated in FIG. 3, the top of connector 10 includes a first open slot 44 adjacent to the left side wall of the connector 10 and a second open slot 45 adjacent to the right side wall of the connector 10. As seen in FIG. 2, the first slot 44 extends past a first ledge 46 and the second slot extends past a second ledge 47. These slots 44 and 45 and ledges 46 and 47 will cooperate with features of the present invention, to be discussed hereinafter.

As seen in FIGS. 1 and 3, the front face 21 of wire retention portion 18 extends beyond the front face of latch 15. Also, the front faces or surfaces of the prior art latch are generally flat, planar surfaces that are perpendicular to the longitudinal axis of insertion holes 20. Also, as seen in FIG. 1, the front face 21 of wire retention portion 18 is substantially vertical when viewed from the side. Thus, when a technician grips the prior art connector to open its top section 12, the technician's thumb will generally press on the small latch grip portion 35 and the front face 21 of wire retention portion 18 with little or no tactile feedback indicating the person's fingers are correctly positioned.

As noted in U.S. Pat. No. 6,457,990, technicians who manually unlatch a connector may accidentally also unlatch a neighboring connector. Such accidental opening often occurs because the soft tissue portion of the technician's thumb may extend past the connector to be opened and cover part of the adjacent connector. That is, the prior art latch design of FIGS. 1-3 does not adequately orient or position a technician's thumb or other finger when the technician attempts to open the connector. U.S. Pat. No. 6,457,990 describes an inventive connector latch structure for the connector 10 which aids in orienting and positioning a technician's thumb on the connector latch member so as to reduce the accidental opening of neighboring IDCs.

### SUMMARY OF THE INVENTION

The Applicant has appreciated one or more drawbacks associated with the designs of the prior art. Even though the latch mechanism of the TIDC has been improved to reduce the likelihood of accidentally unlatching a neighboring TIDC, the possibility still exists. This is particularly troublesome as the neighboring connectors may be provided for essential services, which even if momentarily disconnected could lead to costly financial losses, false alarms or emergency situations, such as when a 911 circuit or an alarm circuit is momentarily disconnected and authorities are alerted, or when a DSL connection is momentarily disconnected and Internet business transactions are interrupted.

Moreover, the inventor has appreciated that technicians often make mistakes in locating the proper TIDC to disconnect. Often a schematic map attached to a door of the BEP must be compared to an actual TIDC layout within the BEP. The technician may make an error in physically locating the proper TIDC corresponding to the TIDC identified in the schematic map. Again, if the erroneously identified TIDC is opened by mistake, costly financial losses, false alarms or emergency situations could result.

It is an object of the present invention to address one or more of the drawbacks of the prior art TIDC designs and/or Applicant's appreciated needs in the art.

The Applicant has appreciated a need in the art for a cap which can cooperate with structural features of various existing TIDCs, such as those illustrated in U.S. Pat. No. 6,457,990, to lock a latch of the TIDC in a closed position. The cap must be disengaged or removed before the TIDC can be unlatched and opened. The cap can be employed on the most important TIDCs within a BEP, or other type of structure for housing TIDCs, to indicate circuits which should typically not be interrupted unless absolutely necessary, such as 911 emergency circuits, PBX circuits, DSL circuits and other types of circuits which need protection against accidental disconnection. The caps may be color coded or include characters or symbols to indicate the nature of the circuit completed by the TIDC to which the cap is attached.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a side sectional view of a TIDC constructed in accordance with the prior art;

FIG. 2 is a front elevational view of the prior art TIDC of FIG. 1;

FIG. 3 is top view of the prior art TIDC of FIG. 1;

FIG. 4 is a perspective view of a locking marker cap, in accordance with the present invention;

FIG. 5 is a front view of the locking marker cap of FIG. 1;

FIG. 6 is a right side view of the locking marker cap of FIG. 1;

FIG. 7 is a top view of the locking marker cap of FIG. 1;

FIG. 8 is a bottom view of the locking marker cap of FIG. 1.

FIG. 9 is a front view of the locking marker cap in alignment with a TIDC and ready to be pushed down onto the TIDC;

FIG. 10 is a front view of the locking marker cap attached to the TIDC; and

FIG. 11 is a cross sectional view taken along line XI-XI in FIG. 10.

### DETAILED DESCRIPTION OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

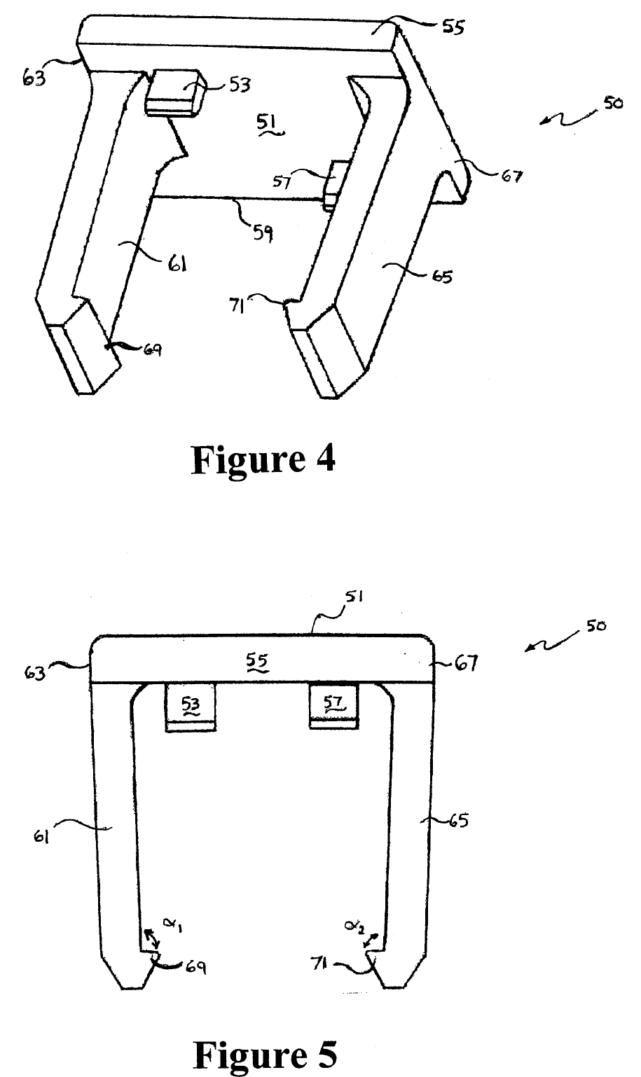

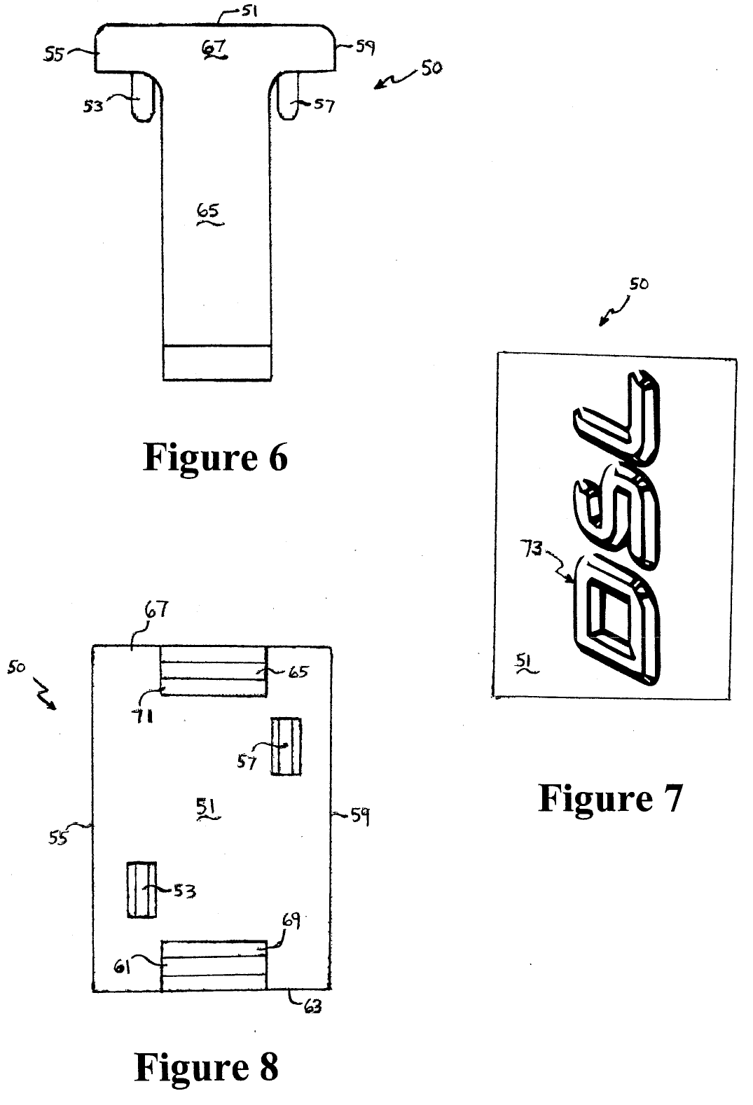

FIGS. 4-8 are various views of a locking marker cap 50 in accordance with one embodiment of the present invention. The cap 50 includes a top 51. A first blocking tab 53 is attached to the top 51 proximate a front or first edge 55. A second blocking tab 57 is attached to the top 51 proximate a back or opposite, second edge 59. As illustrated, each of the first and second blocking tabs 53 and 57 may include canted surfaces or full bull nose surfaces at the distal ends thereof.

A first locking tab 61 is attached to the top 51 proximate a left or third edge 63. A second locking tab 65 is attached to the top 51 proximate a right or opposite, fourth edge 67. The first locking tab 61 includes a first hook 69 at its distal end. The second locking tab 65 includes a second hook 71 at its distal end. The first hook 69 faces to the second hook 71.

Preferably, the first and second locking tabs 61 and 65 are deformable and resilient so that the first and second hooks 69 and 71 may snap over structural features of a TIDC, as will be described in detail hereinafter. In a preferred embodiment, the cap 50 is entirely formed of a plastic material, such that the deformable and resilient aspects of the first and second locking tabs 61 and 65 may be achieved.

As illustrated in FIG. 7, the top 51 is formed generally as a planar member and the upper surface thereof may include indicia 73. The indicia 73 may be formed on or in said top 51 for indicating a nature of a circuit passing through a TIDC to which the cap 50 is to be attached. In FIG. 7, the indicia 73 is illustrated as letters recessed into the top 51 to indicate a DSL circuit. However, other letters or symbols could be formed on or within the top 51 to serve as indicia 73, such as “911” or “PBX”. In a preferred embodiment, no letters or symbols are used for indicia 73, rather a color of the plastic material used to form the cap 50 serves as indicia 73. For example, a purple color could indicate a DSL circuit passing through a TIDC to which the cap 50 is attached and a red color could indicate a 911 circuit. A technician would carry a plurality of caps 50 of several different type colors and use the appropriate colored cap 50 dependent upon the type of circuit passing through the TIDC to be protected.

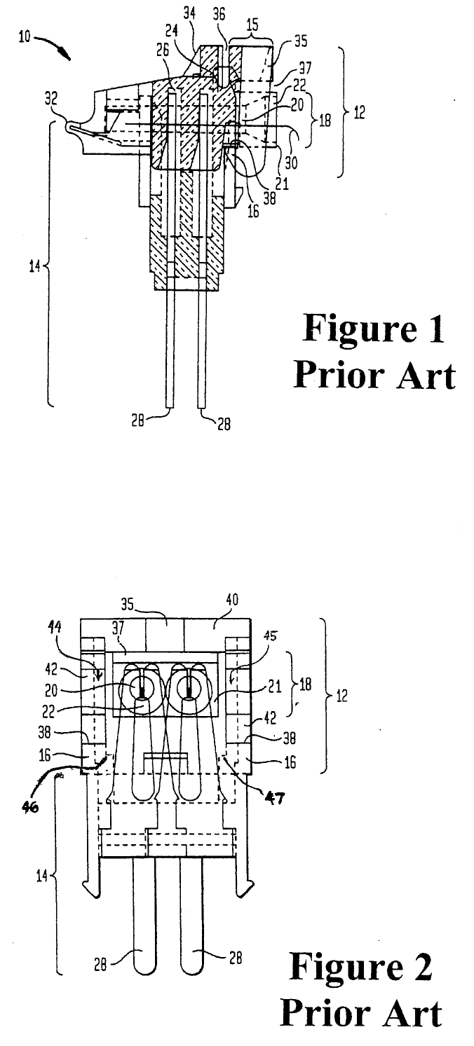

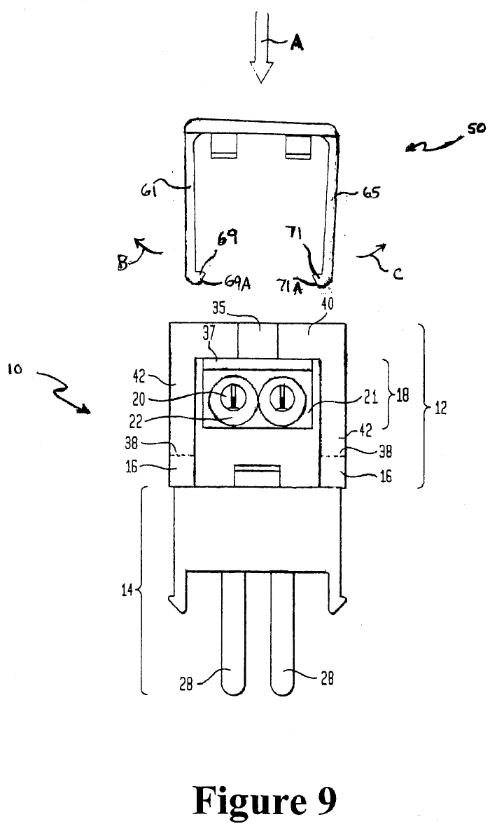

Now with reference to FIGS. 9-11, an interaction between the cap 50 and the TIDC or connector 10 of FIGS. 1-3 will be described in greater detail.

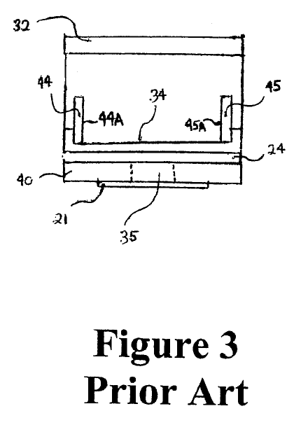

As seen in FIG. 3, the top of the prior art connector 10 includes a first open slot 44 adjacent to the left side wall of the connector 10 and a second open slot 45 adjacent to the right side wall of the connector 10. As seen in FIG. 2, the first slot 44 extends past a first ledge 46 and the second slot extends past a second ledge 47.

To attach the cap 50 to the connector 10, the technician aligns the first locking tab 61 with the first open slot 44 and the second locking tab 65 with the second open slot 45. As illustrated in FIG. 9, by applying a manual force in the direction of arrow A, the first and second locking tabs 61 and 65 will begin to pass into the first and second open slots 44 and 45. As the first and second locking tabs 61 and 65 enter the mouths of the first and second open slots 44 and 45, first and second inward canted surfaces 69A and 71A of the first and second hooks 69 and 71, respectively, will engage inner sidewalls 44A and 45A of the first and second open slots 44 and 45. The engagement will result in a slight deflection of the first and second locking tabs 61 and 65 in the directions of arrows B and C, respectively. The deflections will be slightly resisted by the natural resiliency of the material (e.g., plastic) used to form the cap 50.

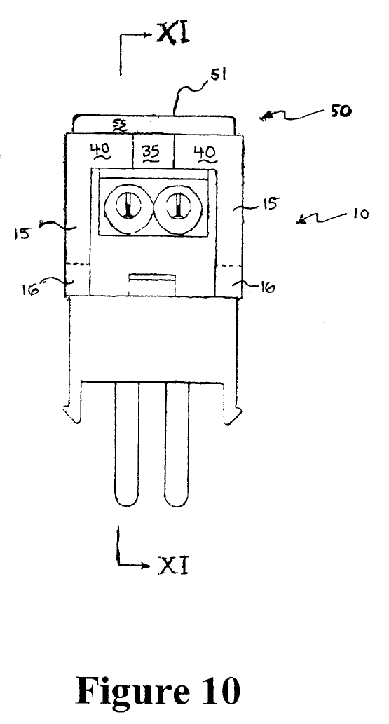

As the cap 50 is pressed further down onto the connector 10, the first hook 69 passes by the first ledge 46 (See FIG. 2) and the second hook 71 passes by the second ledge 47 (See FIG. 2). FIG. 10 illustrates the resulting position of the cap 50 relative to the connector 10. The natural resiliency of the first locking tab 61 causes the first hook 69 to snap past the first ledge 46 (e.g., slightly to the right in FIG. 2). Likewise, the natural resiliency of the second locking tab 65 causes the second hook 71 to snap past the second ledge 47 (e.g., slightly to the left in FIG. 2). Of course, only one locking tab 61 or 65 could possess an ability to deflect and a natural resiliency and the same objectives could be obtained. Such an alternative is within the purview of the claims of the present invention.

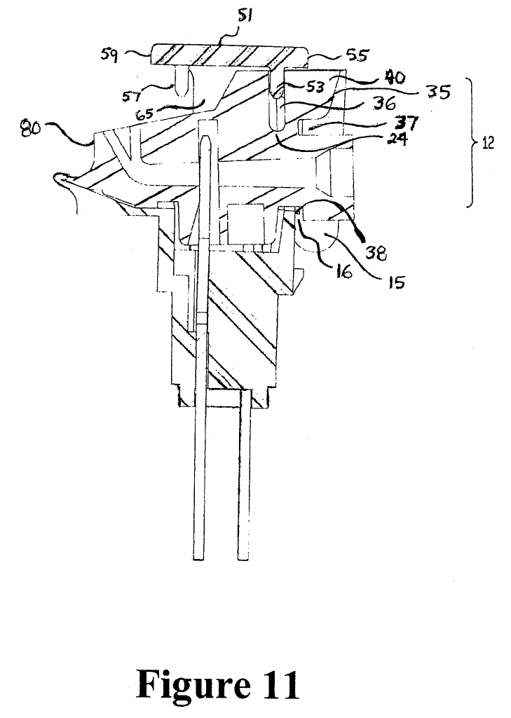

FIG. 11 is a cross sectional view taken along line XI-XI in FIG. 10. As seen in FIG. 11, the first blocking tab 53 resides within the recess 36 of the connector 10 when the cap 50 is attached to the connector 10. Therefore, the first blocking tab 53 resides in a movement path of the latch 15 which prevents the latch 15 from being opened. More specifically, if a user applies squeezing pressure between a rear 80 of the connector 10 and latch grip portion 35 which forms part of the front face of latch 15, the crossbar member 40 of latch 15 will attempt to pivot about living hinge 24 away from channel 37 and toward recess 36. However, the first blocking tab 53 will block the pivoting movement so as to prevent disengagement of the latch engaging portion 16 from latch retaining portion 38. Therefore, the top section 12 is unable to move to its open position, and the circuit made by the connector 10 cannot be disconnected.

To remove the cap 50 from the connector 10, a person can insert his finger into the space located between the underside of top 51 and the top side of the rear 80 of the connector 10 and pull upwards on the cap 50. The upward force will cause the first and second hooks 69 and 71 to pass over the first and second ledges 46 and 47. The amount of force required to dislodge the first and second hooks 69 and 71 from the first and second ledges 46 and 47 is a controlled in part by the fabricator's selection of the angles α₁ and α₂ formed between the hooks 69 and 71 and the extension directions of the locking tabs 61 or 65, as illustrated in FIG. 5. For example, if each angle α₁ and α₂ is approximately ninety two degrees, significant force will be required to dislodge the first and second hooks 69 and 71 from the first and second ledges 46 and 47. Hence, it will be quite difficult to remove the cap 50 by manual force and may even require prying by a straight bladed screw driver. If each angle α₁ and α₂ is approximately one hundred and ten degrees, the force required to dislodge the first and second hooks 69 and 71 from the first and second ledges 46 and 47 will be significantly reduced and the cap 50 can be more easily and manually removed from the connector 10.

As seen in FIG. 11, the second locking tab 57 plays no role in blocking the movement path of the latch 15. The second locking tab 57 has been provided on the cap 50 so that the cap 50 may be universally mounted to the connector 10. In other words, if the cap 50 were rotated one hundred eighty degree around the direction of arrow A in FIG. 9 prior to attachment to the connector 10, the second locking tab 57 would reside within the recess 36. Therefore, the mirror image design of the cap 50 allows the cap 50 to function in either orientation and eliminates the problem of a technician installing a cap 50 in a backwards orientation and not blocking the movement path of the latch 15.

Although FIGS. 1-11 have illustrated a cap 50 which is completely removable from the TIDC or connector 10, it is within the purview of several of the claims that the cap 50 need not be completely removable. For example, a tether could connect the cap 50 to the connector 10 at all times so that the connector 10 and cap 50 are an inseparable unit yet the cap 50 could have first and second positions relative to the connector 10 which block or permit movement of the latch 15.

Although only a single TIDC has been illustrated in the drawing figures, such TIDCs are usually present in groups. For example, gangs of five TIDCs are commonly found in industry. By the present invention, one or more of the TIDCs in a gang could be singled out for marking and locking by the cap 50 of the present invention.

One specific embodiment of a TIDC has been illustrated in FIGS. 1-3 and 9-11. Some of the structural features of the embodiment of the TIDC, which are not relevant to the interaction with the cap of the present invention, have been deleted so as to simplify the drawing figures. The cap of the present invention is not limited to use with the illustrated TIDC embodiment, but rather can be used with differently structured TIDCs.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A cap for attachment to a tool-less insulation displacement connector (TIDC) to block a pivoting movement of a latch of the TIDC while attached to the TIDC comprising:
a top;
at least one blocking tab attached to said top; and
at least one locking tab attached to said top, wherein when said at least one locking tab is engaged to a portion of the TIDC, said blocking tab blocks a pivoting movement path of the latch such that opening of the latch is prohibited.

2. The cap of claim 1, wherein said at least one locking tab includes a hook to engage a portion of the TIDC.

3. The cap of claim 1, wherein said at least one locking tab is a first resilient locking tab, and further comprising:
a second resilient locking tab attached to said top, wherein said first and second resilient locking tabs are located proximate opposing edges of said top.

4. The cap of claim 3, wherein said first resilient locking tab includes a first hook, said second resilient locking tab includes a second hook, and said first and second hooks face each other in order to capture a portion of the TIDC therebetween.

5. The cap of claim 1, wherein said at least one blocking tab is a first blocking tab and further comprising:
a second blocking tab attached to said top.

6. The cap of claim 5, wherein said first and second blocking tabs are located proximate opposing edges of said top.

7. The cap of claim 6, wherein said cap may be attached to said TIDC In two different orientations, in a first orientation said first blocking tab blocks the pivoting movement path of the latch such that opening of the latch is prohibited, and in a second orientation said second blocking tab blocks the pivoting movement path of the latch such that opening of the latch is prohibited.

8. The cap of claim 1, wherein said top is formed as a generally planar member.

9. The cap of claim 1, further comprising:
indicia formed on or in said top for indicating a nature of a circuit passing though the TIDC to which said cap is to be attached.

10. The cap of claim 9, wherein said indicia is in the form of letters or symbols formed on or in a material constituting said top.

11. The cap of claim 9, wherein said indicia is in the form of a color of a material used to form said top.

12. The cap of claim 1, wherein said cap is formed of plastic.

13. A tool-less insulation displacement connector (TIDC) comprising:
a top section and a bottom section, said top section being movable between an open position and a closed position relative to said bottom section;
a latch attached to said top section and having an engaging portion adapted to engage a corresponding retention member on said bottom section to hold said top section in said closed position, wherein said latch can be opened by pivoting said latch such that said engaging portion releases from said retention member so that said top section can be moved to said open position;
wherein the improvement comprises,
a cap attached to said TIDC to prevent opening of said latch of said TIDC including:
a top;
at least one blocking tab attached to said top; and
at least one locking tab attached to said top, wherein when said at least one locking tab is engaged to a portion of said TIDC, said blocking tab blocks a pivoting movement path of said latch such that opening of said latch is prohibited.

14. The TIDC of claim 13, wherein said cap is removably attached to said TIDC and can be removed by disengaging said at least one locking tab from said portion of said TIDC.

15. The TIDC of claim 13, wherein said latch is attached to said top section by a hinge and further comprising:
a recess formed in said top section adjacent to said hinge, wherein a portion of said latch must pivot into said recess when said engaging portion of said latch Is released from said retention member of said bottom section, such that said recess resides In the pivoting movement path of said latch, and wherein said at least one blocking tab occupies said recess when said at least one locking tab is engaged to said portion of said TIDC.

16. The TIDC of claim 13, wherein said at least one locking tab includes a hook, said top section includes a slot extending into said TIDC past a ledge, and said at least one locking tab extends into said slot, and wherein said hook engages said ledge to attached said cap to said TIDC.

17. The TIDC of claim 13, wherein said at least one locking tab is a first resilient locking tab, and further comprising:
a second resilient locking tab attached to said top, wherein said first and second resilient locking tabs are located proximate opposing edges of said top, said first resilient locking tab includes a first hook, said second resilient locking tab includes a second hook, and said first and second hooks face each other in order to capture a portion, of the TIDC therebetween.

18. The TIDC of claim 17, wherein said top section includes a first slot extending into said TIDC past a first ledge and a second slot extending into said TIDC past a second ledge, and said first and second resilient locking tabs extend into said first and second slots respectively, and said first hook engages said first ledge and said second hook engages said second ledge to attached said cap to said TIDC.

19. A method of locking and unlocking a latch on a tool-less insulation displacement connector (TIDC) comprising:
providing a TIDC with a top section and a bottom section, the top section being movable between an open position and a closed position relative to the bottom section; a latch attached to the top section and having an engaging portion adapted to engage a corresponding retention member on the bottom section to hold the top section in the closed position, wherein the latch can be opened by pivoting the latch such that the engaging portion releases from the retention member so that the top section can be moved to the open position;
providing a cap including a top; at least one blocking tab attached to the top; and at least one locking tab attached to the top;
attaching the cap to the TIDC by engaging the at least one locking tab to a portion of the TIDC; and
blocking a pivoting movement path of the latch such that opening of the latch is prohibited by inserting the at least one blocking tab into the pivoting movement path of the latch.

20. The method of claim 19, further comprising:
removing the cap from the TIDC by disengaging the at least one locking tab from the portion of the TIDC; and
permitting pivoting movement of the latch such that opening of the latch is allowed by removing the at least one blocking tab from the pivoting movement path of the latch.
